(19) United States
(12) Patent Application Publication
(10) Pub. No.: US 2026/0036530 A1
(43) Pub. Date: Feb. 5, 2026

(54) SYSTEMS AND METHODS FOR QUANTITATIVE ILLUMINATION CORRECTION

(71) Applicant: Arizona Board of Regents On Behalf of Arizona State University, Tempe, AZ (US)

(72) Inventors: Steve Presse, Scottsdale, AZ (US); Shep Bryan, Phoenix, AZ (US); Ayush Saurabh, Tempe, AZ (US); Douglas Shepherd, Tempe, AZ (US)

(21) Appl. No.: 19/150,044

(22) PCT Filed: Feb. 9, 2024
(86) PCT No.: PCT/US2024/015210

§ 371 Date: Jul. 22, 2025

Related U.S. Application Data
(60) Provisional application No. 63/484,402, filed on Feb. 10, 2023.

(51) Int. Cl. G01N 23/04; G01N 23/046

(52) U.S. Cl. CPC G01N 23/043; G01N 23/046; G01N 2223/102; G01N 2223/406; G01N 2223/413; G01N 2223/419; G01N 2223/423; G01N 2223/501

(57) ABSTRACT

A system applies Bayesian inference techniques to determine parameters of a camera and an illumination profile for an inhomogeneously-illuminated sample from observation data. The system learns full posterior probability distributions over all parameters involved in the imaging process that works in both high illumination and low illumination regimes.

### CROSS REFERENCE TO RELATED APPLICATIONS

This is a PCT international application that claims benefit to U.S. provisional application Ser. No. 63/484,402 filed on Feb. 10, 2023 which is herein incorporated by reference in its entirety.

### GOVERNMENT SUPPORT

This invention was made with government support under R01 GM130745 and R01 GM134426 awarded by the National Institutes of Health. The government has certain rights in the invention.

### FIELD

The present disclosure generally relates to tomography imaging, and in particular, to a system and associated methods for quantitative illumination correction in tomography imaging using a Bayesian framework.

### BACKGROUND

Electron Multiplying Charge Coupled Device (EMCCD) cameras and Scientific Complementary Metal Oxide Semiconductor (sCMOS) cameras are widely used for fluorescence microscopy experiments. However, the quantitative determination of biological parameters uniquely depends on characteristics of the unavoidably inhomogeneous illumination profile as it gives rise to an image. It is therefore of interest to learn this inhomogeneous illumination profiles that can dramatically vary across images alongside the camera parameters though a detailed camera model.

It is with these observations in mind, among others, that various aspects of the present disclosure were conceived and developed.

### BRIEF DESCRIPTION OF THE DRAWINGS

FIG. 1A is a graphical representation showing an example of illumination correction under low-light illumination conditions by a system described herein;

FIG. 1B is a graphical representation showing operating principles of an Electron Multiplying Charge Coupled Device camera;

FIG. 1C is a simplified block diagram showing a system for illumination correction in images of biological samples that infers an illumination profile using observation data;

FIG. 2 is a simplified diagram showing an exemplary computing device for implementation of the system of FIG. 1C; and

FIG. 3 is a process flow diagram showing a method for correcting fluorophore density in images by inferring an illumination profile within observation data of a biological sample;

FIGS. 4A-4F are a series of graphical representations showing benchmarking results of the methods outlined herein on nuclear core complex data;

FIGS. 5A-5F are a series of graphical representations showing benchmarking results of the methods outlined herein on DNA origami data; and

FIGS. 6A-6E are a series of graphical representations showing benchmarking results of the methods outlined herein on simulated fluorophore data.

Corresponding reference characters indicate corresponding elements among the view of the drawings. The headings used in the figures do not limit the scope of the claims.

### SUMMARY

A system for quantitative illumination correction includes a processor in communication with a memory, the memory including instructions executable by the processor to: access observation data including brightness data indicative of one or more light-emitting particles captured across a plurality of frames by an imaging device; sample a set of probability values associated with observing the observation data for values of a plurality of parameters of a measurement model, the plurality of parameters including an illumination profile observable within the observation data; and infer, based on the set of probability values and the observation data, a most probable illumination profile. The plurality of parameters can further include a fluorophore density observable within the observation data, and/or one or more internal camera parameters that affect the observation data including but not limited to: a gain of an electron multiplication register of the imaging device; an offset of the imaging device; and a standard deviation of readout noise associated with the imaging device.

The measurement model can include a posterior probability distribution expressive of a joint probability of observing a light-emitting particle of the one or more light-emitting particles at a particular location within a respective frame across the plurality of frames of the observation data for a fluorophore density and an external illumination profile.

In some examples, the memory can include instructions that are executable by the processor to: apply a Gibbs sampling procedure to iteratively sample the set of probability values associated with the plurality of parameters from the measurement model. The memory can further include instructions executable by the processor to generate one or more images showing a corrected fluorophore density for a frame of the observation data based on the most probable illumination profile.

In examples where the imaging device includes an Electron Multiplying Charge-Coupled Device camera that includes an electron multiplication register, the measurement model can incorporate a total probability of photon excitation, including: a probability that a quantity of photons are incident on a pixel of the imaging device, conditioned on a mean number of incident photons absorbed at the pixel that corresponds with a brightness value of the observation data associated with the pixel; a probability that the electron multiplication register outputs a quantity of electrons, conditioned on a gain of the electron multiplication register and a quantity of input electrons incident at the electron multiplication register; a probability that an analog-digital unit signal associated with the pixel is equal to a particular value given a continuous illumination value of the illumination profile and normalized over the quantity of electrons outputted at the electron multiplication register, conditioned on the quantity of electrons outputted at the electron multiplication register, conditioned on an offset of the imaging device, and conditioned on a standard deviation of readout noise; a probability that a quantity of photons are absorbed as photoelectrons at a pixel of the imaging device, conditioned on a mean number of incident photons absorbed at the pixel and conditioned on a quantum efficiency associated with the imaging device; a probability that a quantity of spurious electrons associated with noise of the imaging device are emitted by the imaging device, conditioned on a mean number of spurious electrons; and a probability that the electron multiplication register absorbs a quantity of input electrons given by convolution of the probability that the quantity of photons are absorbed as photoelectrons and the probability that the quantity of spurious electrons associated with clock induced charge noise of the imaging device are emitted by the imaging device, the quantity of input electrons including a subset of the spurious electrons and the photons absorbed at the pixel.

In examples where the imaging device includes a scientific Complimentary Metal-Oxide Semiconductor (sCMOS) camera, the measurement model can incorporate a total probability of photon excitation, including: a probability that a quantity of photons are absorbed by a pixel of the imaging device, conditioned on a mean number of incident photons absorbed at the pixel that corresponds with a brightness value associated with the pixel from the observation data; and a probability that an analog-digital unit signal associated with the pixel is equal to a particular value, conditioned on a pixel gain of the pixel multiplied by the quantity of photons absorbed by the pixel, conditioned on an offset of the imaging device, and conditioned on a standard deviation of readout noise of the pixel.

In some examples, the memory can include instructions that are executable by the processor to: apply the observation data to the measurement model, the measurement model including a posterior probability distribution expressive of a joint probability of observing a light-emitting particle at a particular location within a respective frame across the plurality of frames given a fluorophore density and an external illumination profile associated with the data; iteratively sample fluorophore density from a posterior probability distribution based on a prior probability distribution on the fluorophore density; and iteratively sample external illumination profile from a posterior probability distribution based on a prior probability distribution on the external illumination profile.

A method for quantitative illumination correction includes: accessing observation data including brightness data indicative of one or more light-emitting particles captured across a plurality of frames by an imaging device; sampling a set of probability values associated with observing the observation data for values of a plurality of parameters of a measurement model, the plurality of parameters including an illumination profile observable within the observation data; and inferring, based on the set of probability values and the observation data, a most probable illumination profile. The measurement model can include a posterior probability distribution expressive of a joint probability of observing a light-emitting particle of the one or more light-emitting particles at a particular location within a respective frame across the plurality of frames of the observation data for a fluorophore density and an external illumination profile. The plurality of parameters can further include a fluorophore density observable within the observation data and/or one or more internal camera parameters that affect the observation data.

The method can further include applying a Gibbs sampling procedure to iteratively sample the set of probability values associated with the plurality of parameters from the measurement model; and generating one or more images showing a corrected fluorophore density for a frame of the observation data based on the most probable illumination profile.

### DETAILED DESCRIPTION

Quantitative fluorescence microscopy provides images whose brightness across pixels is not a direct measure of the underlying fluorophore density. Rather the output is directly tied to the product of the illumination intensity and the fluorophore density. As it is very difficult to achieve homogeneous illumination of a sample, deducing the fluorophore density across all pixels of an image presents profound challenges. A wide variety of “optical flat-fielding” solutions exist (e.g., integration-based beam shapers) though no method is perfect. State-of-the-art computational methods in turn provide qualitative corrections in order to improve the visual appeal, say, of stitched images CITE with method details.

The present disclosure provides a computer-implemented system and associated methods for estimating fluorophore density and illumination profile from images captures by Electron Multiplying Charge Coupled Device (EMCCD) and Scientific Complementary Metal Oxide Semiconductor (sCMOS) cameras using Bayesian inference techniques. The system applies a detailed model to learn inhomogeneous illumination profiles as well as learn associated camera parameters. The system operates within a Bayesian paradigm, allowing determination of full distributions over the unknowns.

### 1. Challenges

EMCCD and sCMOS cameras are used to image a wide variety of systems under both high and low light conditions. To take images of these systems, proteins of interest are first tagged with fluorescent labels and the labels are illuminated under a microscope. As phototoxicity is an unavoidable problem of laser illumination, the sample must be illuminated with minimal brightness. Under low light illumination levels, EMCCD and sCMOS cameras are ideal candidates for recording images because they amplify signals with an electron multiplication register, however, the electron multiplication register also introduces noise to measurements. Furthermore, artifacts such as inhomogeneous illumination are amplified in the EM register. In order to make accurate inferences from EMCCD measurements, the system must be able to quantify the noise from the EM register as well as the illumination.

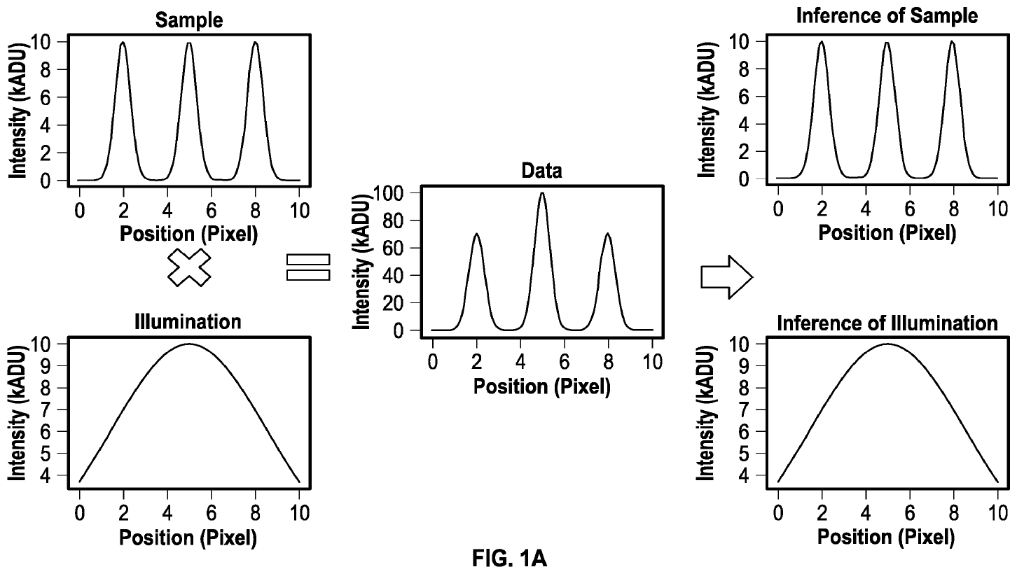

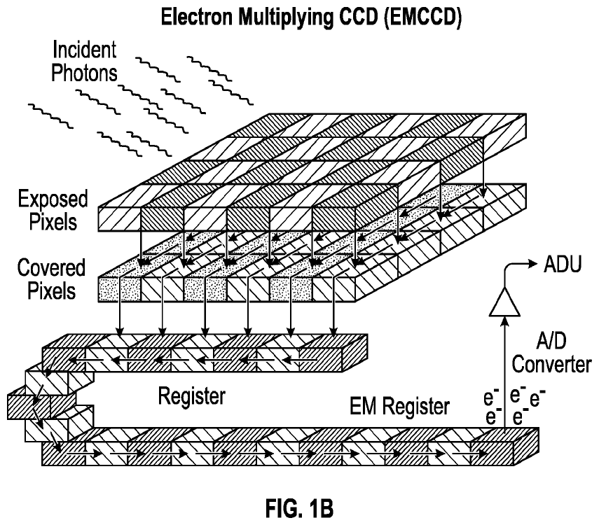

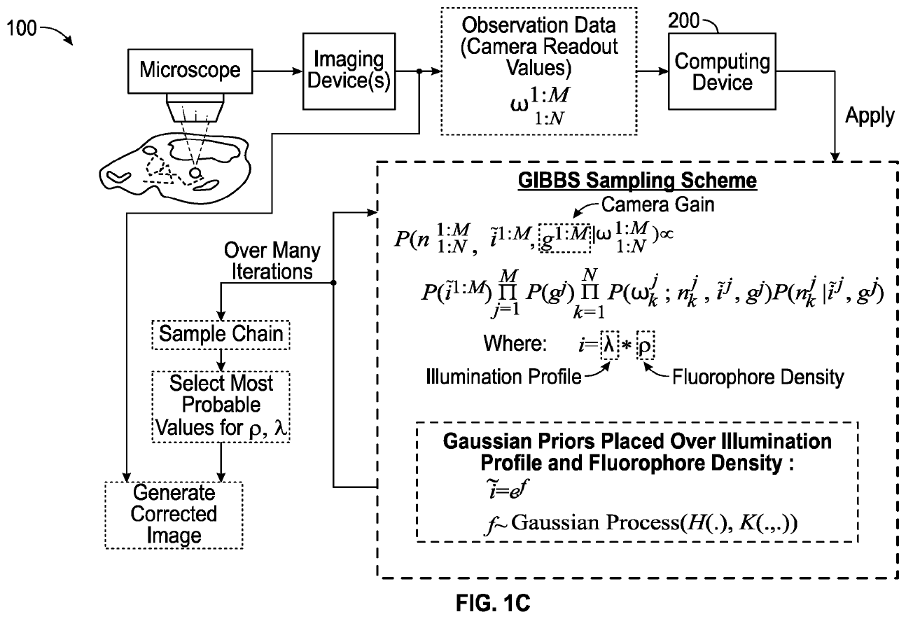

To illustrate the problem addressed by the system, consider FIG. 1A. Here, a simulated data is presented including 1D image of a collection of evenly-spaced clusters including the same number of fluorophores illuminated with typical Gaussian vignetting at the edges. The vignetting results in lower illumination levels at the edges and higher illumination levels in the center of the image. As a consequence, the fluorophore clusters at the center of the image appear brighter than the fluorophores at the edges of the image despite having the same number of fluorescent labels. The difference in brightness can be seen by eye in the center of FIG. 1A. What is needed is a method that can correct the image to account for uneven illumination. The right side of FIG. 1A shows the corrected image using the method presented herein.

There are existing experimental techniques to correct for inhomogeneous illumination. Many of these methods use optical flat-fielding systems including field-mapping or integration-based beam shapers to transform inhomogeneous illumination into homogeneous illumination. These include the field-mapping beam shapers, PiShaper and TopShape, and the integration-based beam shaper, Köhler integrator. Others use a multimode fiber and a laser speckle-reducer to achieve homogeneous illumination. The goal of these methods is to illuminate the sample as evenly as possible, however, no method will be perfect at supplying a perfectly homogeneous beam. Therefore, it is still of interest to have a computational method to correct for the inhomogeneity.

To address the experimental limitations of inhomogeneous illumination correction, there exist computational methods, such as BASIC and CIDRE, which are used to treat the illumination artifacts. These methods are not specific to any type of camera and focus only on general residual and additive noise and simple multiplicative factors. The advantage of these methods is that they do not require dark or flat field images, although they still require calibration through marginalization over many images. Despite this, these methods do not account for specific camera noise or internal parameters of the camera, and as such are used primarily for qualitative as opposed to quantitative image corrections.

### 2. Methods

The present disclosure outlines a full generative model that describes the interaction of the sampler and individual pixels within the camera. Using Bayes' theorem and tools from Bayesian non-parametrics, the generative model can be extended to create an inverse model which allows inference of the parameters of the camera including the inhomogeneous illumination profile. As such, the system can learn full posterior probability distributions over all parameters involved in the imaging process that work in both high illumination and low illumination regimes.

One goal of the system is to determine internal parameters of the camera (electron multiplier gain, g; output photo-electrons, nₒ; the readout noise, σ; the offset, o; and the clock induced charge noise, c) and a spatially continuous illumination profile (λ(x)) starting from a collection of images (e.g., observation data) and calibration data. In this section, methods applied by the system are described by first building a generative model that describes the imaging process for a single pixel, then showing how the system can use Bayes' theorem to turn the generative model into an inverse model for the whole image. The system applies a sampling scheme to numerically sample variables from the high dimensional posterior probability distribution.

For the model, a probability of photon excitation can be described using a Poisson distribution (the number of photons is Poisson distributed around the fluorophore density of the pixel times the illumination profile). The output is convoluted with a binomial distribution describing the photon absorbance, then added to a Poisson random variable. This final value is then convoluted with a Gamma distribution describing the EM register, then convoluted with a normal distribution which encodes the offset and readout noise.

The fluorophore density and illumination profile can be inferred by placing Gaussian process prior probability distributions on each of them then using a Markov Chain Monte Carlo sequence to find profiles that maximize the posterior. In some aspects, calibration data may be required in order to infer the illumination profile.

To start, let ρ be the 2-dimensional density of the sample to be studied. For example, ρ can represent fluorophore density over a grid of 256×256 pixels. Let λ be the 2-dimensional continuous illumination illuminating the sample. Assume in general λ is not uniform and is therefore inhomogeneous illumination. Assume the output brightness i (photons/frame) is proportional to both λ and p; infer i=λ*ρ. In general, ρ can not be known precisely and therefore the system can learn λ up to a scaling factor. This disclosure shows how to uncover λ from data on a single pixel, and generalizes this concept this to multiple pixels.

### 2.1 EMCCD Forward Model on Single Pixel

FIG. 1B shows how incident photons are converted into photoelectrons, which travel through an EM register through the A/D converter before reaching us as measurements in ADUs.

As shown in FIG. 1B, the ADU measurement for a single pixel is related to the intensity in 5 steps: 1) the sample with mean number of photons per frame i=λ*ρ will cause ϕ photons to be absorbed by the pixel; 2) the ϕ photons have a quantum efficiency q to emit nₑ photoelectrons into the circuitry; 3) clock induced charge (CIC) noise will emit a number of additional “noise” electrons c; 4) the Electron Multiplier with gain, g, causes the nₑ+c electrons to give rise to nₒ final electrons; and 5) the nₒ final electrons are converted into ADUs, w, under readout noise with standard deviation, σ. All together the distribution becomes:

$$( 1 )$$

$$P ( w \vert {Θ}_{1 : N} ) = \int {dn}_{o} {dn}_{c} {dn}_{e} d ϕ P ( w \vert σ , {n}_{o} ) P ( {n}_{o} \vert g , {n}_{e} , {n}_{c} ) P ( {n}_{c} \vert c ) P ( {n}_{e} \vert q , {n}_{ϕ} ) P ( {n}_{ϕ} \vert i )$$

where Θ_{1:N} are the parameters of the camera. The likelihoods for the quantities of interest, i and g are recovered through marginalization of (trivial) quantities, nₒ, n_{c}, nₑ, and ϕ. For the remainder of this section, Eq. 1 is broken down piece-by-piece.

Starting with the rightmost term in Eq. 1, the probability that ϕ photons are incident on a pixel is conditioned on the mean number of incident photons (i.e., the brightness of the pixel), i, through a Poisson distribution:

$$P ( ϕ ; i ) = Poisson ( ϕ ; i ) .$$

Each photon has probability q chance of being absorbed, where q is the quantum efficiency. Each absorbed photon causes a single photo-electron to be produced into the circuitry. The number of photoelectrons, nₑ, is conditioned on the number of photons, ϕ, and the quantum efficiency, q, through a binomial distribution which when marginalized over ϕ becomes a Poisson distribution with a rate parameter reweighted by the quantum efficiency:

$$P ( {n}_{e} ; i , q ) {\sum }_{ϕ = 0}^{∞} Binomial ( {n}_{e} ; q , ϕ ) Poisson ( ϕ ; i ) \qquad ( 2 )$$

$$= Poisson ( {n}_{e} ; iq ) . \qquad ( 3 )$$

Additionally, within the detector array, before the photo-electrons enter the EM register, some spurious electrons may be emitted during the parallel and serial shifts in the circuitry, in the form of Clock Induced Charge (CIC) noise. The probability of nₛ such electrons being emitted is conditioned on the mean number of spurious electrons, c, through a Poisson distribution:

$$P ( {n}_{s} \vert c ) = Poisson ( {n}_{w} ; c ) . \qquad ( 4 )$$

The photo-electrons and spurious electron are added together before the Electron-Multiplication register (EM register). Consequently, the probability of nᵢ electrons entering the EM register is given by a convolution of the two Poisson distributions which yields another Poisson distribution (see SI).

$$P ( {n}_{i} ; λ ) = Poisson ( {n}_{i} ; \tilde{i} ) \qquad ( 5 )$$

where ĩ=qi+c is the effective brightness. Because this effective brightness, î, is equal to the true brightness, i, under a linear transformation, no information is lost by recasting our attention on ĩ instead of i. In fact, accurate calibration of q and c are difficult and do not yield any additional insight aside into the images. Therefore, for the remainder of this disclosure, ĩ will be references as the quantity to be inferred by the system.

Moving on, the number of electrons output by the EM register, nₒ, is conditioned on the camera gain, g, and number of input electrons, nᵢ, through a distribution that is well-approximated by a Gamma distribution when the number of input electrons is greater than zero and gives exactly zero output electrons, nₒ when the number of input electrons, nᵢ is zero:

$$P ( {n}_{o} \vert g , {n}_{i} ) = \{ \begin{matrix}Gamma ( {n}_{o} ; g , {n}_{i} & when {n}_{i} > 0 \\ Delta ( {n}_{o} ) & when {n}_{i} = 0\end{matrix} \qquad ( 6 )$$

where Delta (nₒ) is the Dirac delta distribution, used here to indicate that if zero input electrons are found then zero output electrons will be emitted. When nᵢ>0, the model can be simplified by directly marginalizing over nᵢ in equations 5 and 6 to find nₒ conditioned on ĩ.

$$P ( {n}_{o} \vert \tilde{i} , g ) = \int {dn}_{i} P ( {n}_{o} \vert g , {n}_{i} ) P ( {n}_{i} \vert \tilde{i} ) \qquad ( 7 )$$

$$= \frac{2}{g} {F}_{𝒳} ( 2 \tilde{i} ; 4 , 2 {n}_{o} / g ) \qquad ( 8 )$$

where F_{χ} is the non-central χ² distribution for 2λ with 4 degrees of freedom and non-centrality parameter 2nₒ/g. Including the case where the number of input electrons is zero, the distribution for the number of input electrons given the incident number of electrons is:

$$P ( {n}_{o} \vert \tilde{i} , g ) = Delta ( {n}_{o} ) Poisson ( 0 ; \tilde{i} ) + \frac{2}{g} {F}_{𝒳} ( 2 \tilde{i} ; 4 , 2 {n}_{o} / g ) . \qquad ( 9 )$$

The final readout in ADUs, w, is conditioned on nₒ, the offset, b, and the standard deviation of the readout noise, σ, through a Normal distribution:

$$P ( w \vert {n}_{o} , b , σ ) = Normal ( w ; {n}_{o} + b , {σ}^{2} ) \qquad ( 10 )$$

To recover the full likelihood for w given λ, marginalizing over nₒ.

$$P ( w ; \tilde{l} , g , σ ) = Poisson ( 0 ; \tilde{l} ) Normal ( w ; b , σ ) + {\int }_{{n}_{o = 0}}^{∞} Normal ( w ; {n}_{o} + b , σ ) \frac{2}{g} {F}_{𝒳} ( 2 \tilde{l} ; 4 , 2 {n}_{o} / g )$$

### 2.2 CMOS Forward Model

Scientific Complementary Metal Oxide Semiconductor (sCMOS) cameras are much simpler to model as there are fewer sources of noise than EMCCD cameras.

The probability that ϕ photons are absorbed by a pixel is conditioned on the mean number of incident photons, i=λ*p, through a Poisson distribution (where ĩ=qi just as in the EMCCD model but without clock induced charge which can be absorbed into the offset parameter):

$$P ( ϕ ; \tilde{i} ) = Poisson ( ϕ ; \tilde{i} ) .$$

The final readout in ADUs, w, is conditioned on the pixel's gain times the incident photons, gϕ, the offset, b, and the pixel's standard deviation of the readout noise, σ, through a Normal distribution.

$$P ( w \vert ϕ , b , σ ) = Normal ( w ; g ϕ + b , {σ}^{2} ) \qquad ( 11 )$$

Therefore, the full distribution is a convolution of a Poisson and normal distribution. Note that for computational reasons, the system does not marginalize over ϕ because ϕ can be learned:

$$P ( w \vert ϕ , b , σ , g , \tilde{ι} ) = Normal ( w ; g ϕ + b , {σ}^{2} ) Poisson ( ϕ ; \tilde{ι} ) . \qquad ( 12 )$$

One last thing to note about how sCMOS and EMCCD differ is that sCMOS pixels each have their own gain and readout noise. Therefore, these parameters vary pixel to pixel and must be learned individually.

### 2.3 Offset and Readout Noise

When learning the parameters of this model, it is convenient and easy to precalibrate the offset, b, and variance, σ². Precalibration can be done by taking movies in which no photons enter the detector. This can be done by simply keeping the camera cap on the microscope and recording a movie. Because no photons enter the camera, any noise in the movies are due solely due to variance and offset. The mean readout is the offset, b, and the variance is the camera variance, σ². In principle, the variance and offset can be considered by the system, but introduction of additional random variables increases the uncertainty of each parameter so in some cases it may be best to precalibrate these quantities. For the rest of this disclosure, assume that the offset has been subtracted from the observation data.

### 2.4 Posterior

Now, the system can use the forward model to infer parameters.

FIG. 1C shows an example implementation of a system 100 for correcting fluorophore density in observation data by inferring an illumination profile. The system 100 can include an imaging device in communication with a microscope that captures observation data, which can be in the form of images, expressed in FIG. 1C as

$${w}_{1 : N}^{1 : M} .$$

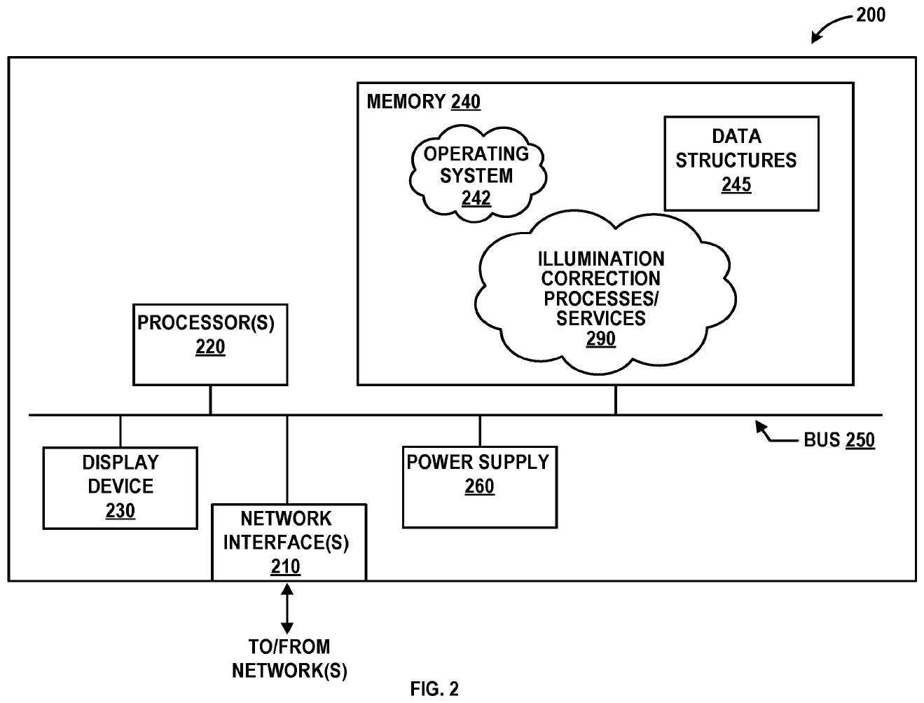

The imaging device can provide the observation data as input to a computing device 200 (see FIG. 2), which can apply the methods outlined herein to a measurement model that enables sampling of probability values associated with parameters involved in the imaging process, and then selecting values of the parameters that maximize a posterior probability distribution. The measurement model may be an inverse model version of the EMCCD and sCMOS forward models presented in sections 2.1 and 2.1 of the present disclosure. These parameters can include a most probable illumination profile/which is related to fluorophore density ρ and brightness i by a relation i=λ*p. Other parameters include internal camera parameters that affect the observation data, such as but not limited to: gain, output photoelectrons, readout noise, offset, and clock-induced charge noise. To sample these probability values, the computing device 200 can apply a Markov Chain Monte Carlo scheme, and in particular, a Gibbs sampling scheme. Probabilities associated with the illumination profile λ and fluorophore density ρ can be sampled within the Gibbs sampling scheme using Gaussian process priors to find profiles that maximize the posterior. In some examples, calibration data (e.g., values of the internal camera parameters) may be found before inference of the illumination profile.

Over many iterations of the MCMC/Gibbs sampling scheme, the computing device 200 produces a sample chain that includes samples of the probabilities associated with various values of the plurality of parameters. The computing device 200 can select the most probable values of the plurality of parameters, including a most probable illumination profile. The computing device 200 can generate a corrected image from the original observation data based on the most probable illumination profile.

The system 100 applies Bayes' Theorem to the forward model to derive a multidimensional probability distribution for g, ĩ^{j}, and

$${n}_{o}^{j}$$

given (σ^{j})² and w^{j}, where j is the index of these quantities for the jth pixel. Note for EMCCD cameras g^{j}=g^{k} and (σ^{j})²=(σ^{k})² for separate j and k pixels, but this is not true for sCMOS cameras. Given a single pixel and N frames,

$${w}_{1 : N}^{j} = \{ {w}_{1}^{j} , {w}_{2}^{j} , {w}_{N}^{j} \} ,$$

with the kth frame having

$${n}_{k}^{j}$$

output electrons the full likelihood for one pixel is the following:

$$P ( {n}_{1 : N}^{j} , {ι}^{j} , {g}^{j} \vert {w}_{1 : N}^{j} ) ∝ P ( {w}_{1 : N}^{j} \vert {n}_{1 : N} , {\tilde{ι}}^{j} , g ) P ( {n}_{1 : N}^{j} , {\tilde{ι}}^{j} , {g}^{j} ) = P ( {\tilde{ι}}^{j} ) P ( {g}^{j} ) {\prod }_{k = 1}^{N} P ( {w}_{k}^{j} ; {n}_{k}^{j} , {\tilde{ι}}^{j} , {g}^{j} ) P ( {n}_{k}^{j} \vert {\tilde{ι}}^{j} , {g}^{j} ) \qquad ( 13 )$$

where individual measurements are identically independently distributed to separate the likelihood into a product. The terms inside of the product are those outlined in sections 2.1 and 2.2 of the present disclosure. The terms outside of the product are prior probability distributions that must be carefully selected and will be described below. To generalize the model to all pixels simultaneously, assume M separate pixels with N total frames.

$$P ( {n}_{1 : N}^{1 : M} , {\tilde{ι}}^{1 : M} , {g}^{1 : M} \vert {w}_{1 : N}^{1 : M} ) ∝ P ( {w}_{1 : N}^{1 : M} \vert {n}_{1 : N} , {\tilde{ι}}^{1 : M} , g ) P ( {n}_{1 : N}^{1 : M} , {\tilde{ι}}^{1 : M} , {g}^{1 : M} ) = P ( {\tilde{ι}}^{1 : M} ) {\prod }_{j = 1}^{M} P ( {g}^{i} ) {\prod }_{k = 1}^{N} P ( {w}_{k}^{j} ; {n}_{k}^{j} , {\tilde{ι}}^{j} , {g}^{j} ) P ( {n}_{k}^{j} \vert {\tilde{ι}}^{j} , {g}^{j} ) \qquad ( 14 )$$

A gamma distribution is selected for the prior probability distribution on g^{j} because the gamma distribution is strictly positive like g^{j}:

$$P ( {g}^{j} ; {α}_{g}^{j} , {β}_{g}^{j} ) = Gamma ( {g}^{j} ; {α}_{g}^{j} , {β}_{g}^{j} ) \qquad ( 15 )$$

When working with EMCCD cameras, g is the same for each pixel; however, when working with sCMOS cameras, each g^{j} gets its own prior.

ĩ^{1:M} can be treated as a 2-dimensional continuous function. This is because ĩ is dependent on ρ*λ which are 2 dimensional continuous functions over the sample region. The 2-dimensional continuous function is denoted as ĩ. The system aims to estimate ĩ at each pixel j in order to recover ĩ^{j}. The brightness of the sample under individual pixels is correlated. That is, nearby pixels should have similar brightness. This can be modeled using a two-dimensional Gaussian Process. A Gaussian process is simply a multivariate normal distribution with a special covariance matrix. Since ĩ should be greater or equal to 0, but a Gaussian Process allows negative values:

$$\tilde{ι} = {e}^{f} \qquad ( 16 )$$

$$f ∼ GaussianProcess ( H ( \cdot ) , K ( \cdot , \cdot ) ) \qquad ( 17 )$$

where ĩ, and j are the indexes of the pixel in question and K(·,·) is the Gaussian process kernel chosen to be:

$$K ( x , y ) = {τ}^{2} exp ( - \frac{1}{2 {l}^{2}} {‖ \vec{x} - \vec{y} ‖}^{2} ) \qquad ( 18 )$$

and H(·) is the Gaussian process mean. This value can be set equal to 0. ĩ^{j}=ĩ (x^{j},y^{j}) can then be sampled, where x^{j} and y^{j} are the x and y positions of the jth pixel.

Since EMCCD cameras can have up to millions of pixels, an inducing point method may be employed. For this, the system samples noise on a smaller number of discretely spaced pixels, uₘ and uses this to estimate f( ) by the following formula:

$${f}_{n} = {K}_{n m}^{*} {K}_{m m}^{- 1} {u}_{m} \qquad ( 19 )$$

where Kₙₘ is the covariance kernel describing the inducing points to the real points, Kₘₘ is the covariance kernel describing the inducing points to themselves, and

$${K}_{n m}^{*}$$

is the inverse of Kₙₘ.

For EMCCD cameras, the output photo-electron on pixel j and frame k is dependent on ĩ^{j} and g (no j script because each gain is the same for EMCCD cameras) by:

$$P ( {n}_{k}^{j} \vert {\tilde{ι}}^{j} , g ) = \frac{2}{g} {F}_{χ} ( 2 \tilde{ι} ; 4 , 2 {n}_{k}^{j} / g ) \qquad ( 20 )$$

where F_{χ} is the non-central χ² distribution for 2ĩ^{j} with 4 degrees of freedom and non-centrality parameter

$$2 {n}_{k}^{j} / g .$$

Therefore, within Gibus Sampling, when sampling g and ĩ^{j}, this is the prior on

$${n}_{k}^{j} .$$

For sCMOS cameras, the output electrons can simply be ignored since the readout noise is simply a Normal distribution centered at g^{j}*ĩ^{j}.

### 3. Computer-Implemented System and Methods

### 3.1 Computing Device

FIG. 2 is a schematic block diagram of an example device 200 that may be used with one or more embodiments described herein, e.g., as a component of the system 100 of FIG. 1C and implementing aspects of the methods outlined above.

Device 200 comprises one or more network interfaces 210 (e.g., wired, wireless, PLC, etc.), at least one processor 220, and a memory 240 interconnected by a system bus 250, as well as a power supply 260 (e.g., battery, plug-in, etc.). Device 200 can also include or otherwise communicate with a display device 230 which can display results of the methods outlined herein, such as one or more images showing a corrected fluorophore density based on the illumination profile.

Network interface(s) 210 include the mechanical, electrical, and signaling circuitry for communicating data over the communication links coupled to a communication network. Network interfaces 210 are configured to transmit and/or receive data using a variety of different communication protocols. As illustrated, the box representing network interfaces 210 is shown for simplicity, and it is appreciated that such interfaces may represent different types of network connections such as wireless and wired (physical) connections. Network interfaces 210 are shown separately from power supply 260, however it is appreciated that the interfaces that support PLC protocols may communicate through power supply 260 and/or may be an integral component coupled to power supply 260.

Memory 240 includes a plurality of storage locations that are addressable by processor 220 and network interfaces 210 for storing software programs and data structures associated with the embodiments described herein. In some embodiments, device 200 may have limited memory or no memory (e.g., no memory for storage other than for programs/processes operating on the device and associated caches). Memory 240 can include instructions executable by the processor 220 that, when executed by the processor 220, cause the processor 220 to implement aspects of the system and the methods outlined herein.

Processor 220 comprises hardware elements or logic adapted to execute the software programs (e.g., instructions) and manipulate data structures 245. An operating system 242, portions of which are typically resident in memory 240 and executed by the processor, functionally organizes device 200 by, inter alia, invoking operations in support of software processes and/or services executing on the device. These software processes and/or services may include illumination correction processes/services 290, which can include aspects of methods and/or implementations of various modules described herein. Note that while illumination correction processes/services 290 is illustrated in centralized memory 240, alternative embodiments provide for the process to be operated within the network interfaces 210, such as a component of a MAC layer, and/or as part of a distributed computing network environment.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules or engines configured to operate in accordance with the techniques herein (e.g., according to the functionality of a similar process). In this context, the term module and engine may be interchangeable. In general, the term module or engine refers to model or an organization of interrelated software components/functions. Further, while the illumination correction processes/services 290 is shown as a standalone process, those skilled in the art will appreciate that this process may be executed as a routine or module within other processes.

### 3.2 Computer-Implemented Method

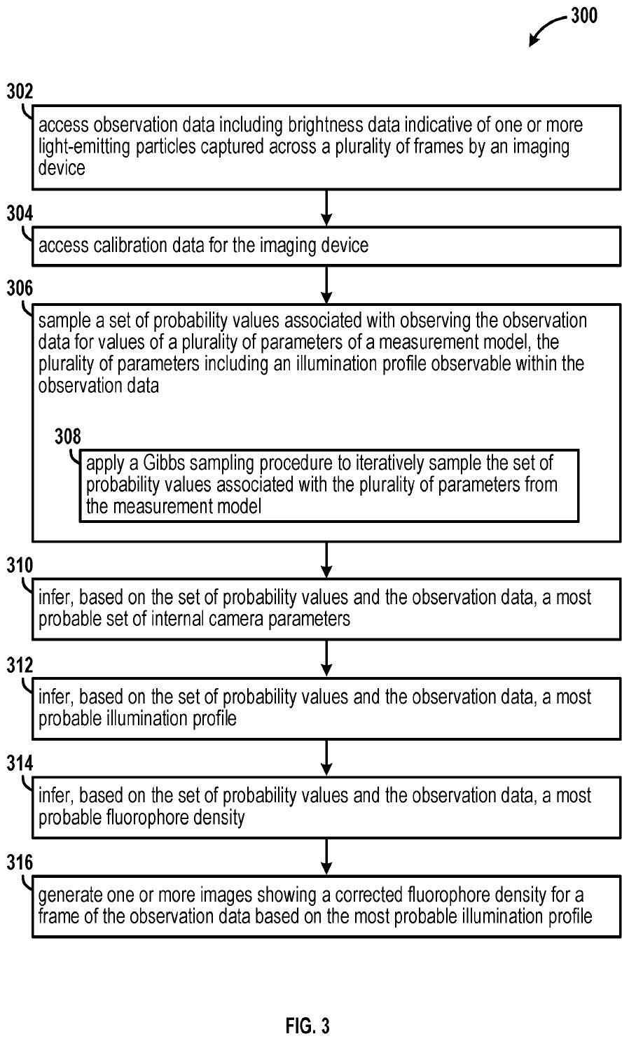

A method 300 outlined herein and shown in FIG. 3 for correcting fluorophore density in images by inferring an illumination profile within observation data of a biological sample may be implemented using computing device 200 of FIG. 2 (e.g., as part of illumination correction processes/services 290) in accordance with the system 100 shown in FIG. 1C. The method 300 corresponds with FIG. 1C and its corresponding discussion, as well as the Methods presented in section 2 of the present disclosure.

Note that inferring the illumination profile may require inferring internal camera parameters. Some of the internal camera parameters can be found by calibration, and/or may be inferred/sampled using the posterior probability distribution outlined in section 2 of the present disclosure. Inferring the illumination profile enables inference of fluorophore density through the relationship i=λ*ρ, where i is output brightness. The illumination profile (and any other parameters) can be used to produce one or more corrected images.

Step 302 of method 300 can include accessing observation data including brightness data indicative of one or more light-emitting particles captured across a plurality of frames by an imaging device. The observation data can be in the form of a plurality of images captured by the imaging device. In some examples, step 304 can include accessing calibration data for the imaging device.

Step 306 of method 300 can include sampling a set of probability values associated with observing the observation data for values of a plurality of parameters of a measurement model, the plurality of parameters including an illumination profile observable within the observation data. The measurement model can include a posterior probability distribution expressive of a joint probability of observing a light-emitting particle of the one or more light-emitting particles at a particular location within a respective frame across the plurality of frames of the observation data for a fluorophore density and an external illumination profile. The plurality of parameters can also include a fluorophore density observable within the observation data. Further, the plurality of parameters can include one or more internal camera parameters that affect the observation data, which can include: a gain of the imaging device (when applicable, such as for EMCCD imaging devices, the gain can be associated with an electron multiplication register of the imaging device); an offset of the imaging device; and a standard deviation of readout noise associated with the imaging device.

When the imaging device is an EMCCD camera, the measurement model can incorporate a total probability of photon excitation, including:
a probability that a quantity of photons are incident on a pixel of the imaging device, conditioned on a mean number of incident photons absorbed at the pixel that corresponds with a brightness value of the observation data associated with the pixel;
a probability that the electron multiplication register outputs a quantity of electrons, conditioned on a gain of the electron multiplication register and a quantity of input electrons incident at the electron multiplication register;
a probability that an analog-digital unit signal associated with the pixel is equal to a particular value given a continuous illumination value of the illumination profile and normalized over the quantity of electrons outputted at the electron multiplication register, conditioned on the quantity of electrons outputted at the electron multiplication register, conditioned on an offset of the imaging device, and conditioned on a standard deviation of readout noise;
a probability that a quantity of photons are absorbed as photoelectrons at a pixel of the imaging device, conditioned on a mean number of incident photons absorbed at the pixel and conditioned on a quantum efficiency associated with the imaging device;
a probability that a quantity of spurious electrons associated with noise of the imaging device are emitted by the imaging device, conditioned on a mean number of spurious electrons; and
a probability that the electron multiplication register absorbs a quantity of input electrons given by convolution of the probability that the quantity of photons are absorbed as photoelectrons and the probability that the quantity of spurious electrons associated with clock induced charge noise of the imaging device are emitted by the imaging device, the quantity of input electrons including a subset of the spurious electrons and the photons absorbed at the pixel.

When the imaging device is an EMCCD camera, the measurement model can incorporate a total probability of photon excitation, including:
a probability that a quantity of photons are absorbed by a pixel of the imaging device, conditioned on a mean number of incident photons absorbed at the pixel that corresponds with a brightness value associated with the pixel from the observation data; and
a probability that an analog-digital unit signal associated with the pixel is equal to a particular value, conditioned on a pixel gain of the pixel multiplied by the quantity of photons absorbed by the pixel, conditioned on an offset of the imaging device, and conditioned on a standard deviation of readout noise of the pixel.

Step 306 can be implemented using step 308, which can include applying a Gibbs sampling procedure to iteratively sample the set of probability values associated with the plurality of parameters from the measurement model. Note that probability values associated with some parameters (such as internal camera parameters) can be sampled directly from the posterior probability distribution. Other probability values associated with some parameters (such as fluorophore density and illumination profile) can be sampled within the Gibbs sampling procedure using a Gaussian process.

Following conclusion of step 306 (including step 308) step 310 includes inferring, based on the set of probability values and the observation data, a most probable set of internal camera parameters. Step 312 can include inferring, based on the set of probability values and the observation data, a most probable illumination profile. Step 314 can include inferring, based on the set of probability values and the observation data, a most probable fluorophore density.

Step 316 can include generating one or more images showing a corrected fluorophore density for a frame of the observation data based on the most probable illumination profile.

### 4. Results

This section benchmarks the methods outlined herein on simulated and experimental data, starting by looking at images of a real system: Nuclear Pore Complexes. After that, the present disclosure considers performance on images of DNA origami, and also considers data including simulated evenly=spaced fluorophore clusters with flat background and uneven illumination.

### 4.1 Data Acquisition

A Nikon Eclipse Ti microscope with dual Hamamatsu Orca-flash 4.0 cameras was used to capture all images. Hamamatsu cameras are equipped with a pixel autocorrection algorithm, which was deactivated before data collection to avoid automatic averaging out of hot pixels. Samples were excited with a 470 nm laser at an exposure time of 700 ms through a Nikon S Plan Flour 40×/0.60 objective. Freshly prepared fluorescein slides, used to capture flat field illumination images, as well as an Argo-SIM-v2 fluorescent calibration slide (Argolight) were used as samples to test the methods outlined herein. Briefly, sodium fluorescein (Sigma-Aldrich) was dissolved in ultra-pure water at a concentration of 0.25 g/mL. The solution was briefly vortexed and subsequently sonicated for 3 hours. After the fluorescein solution was completely dissolved, 20 μL of the resulting dye was mounted onto a glass slide with glass coverslip (thickness #1). One pattern was selected from the fluorescent calibration slide and imaged centered in the frame and at each corner of the frame. Dark frame images were captured with the optics line and microscope shielded from light with no illumination with 700 ms exposure time. For gain measurements, cameras were removed from optics setup, and were directly illuminated with a uniform light source from a LED Light Pad. Data was collected at 3 different illumination levels at 700 ms exposure times. All data was collected using Nikon's NIS-Elements software.

Custom brightness DNA origami with 35 nominal binding sites labelled with ATTO 647N (Gattaquant DNA Nanotechnologies, Germany) were prepared in 0.5×TBE (Tris-borate-ethylenediaminetetraacetic acid) buffer including 11 mM MgCl2 and stored at −20° C. until use. DNA origami were immobilized via biotin-streptavidin linkage in eight-well LabTek (Nunc/Thermo Fisher, USA) chambered coverslips as previously described (Grußmayer and Herten, 2017). Coverslips were cleaned with 0.1 M hydrofluoric acid for 2×30 s and washed with PBS before immobilization. Prepared samples were stored in PBS supplemented with 10 mM MgCl2 before experiments.

U2OS cells stably expressing NUP107-SNAP-tag (a gift of Jan Ellenberg (EMBL Heidelberg) (Otsuka and Ellenberg, 2017)) were cultured in DMEM supplemented with GlutaMax and 1 mM sodium pyruvate (all Life Technologies, USA). Cells were cultured at 37° C., 5% CO2 in a humidified atmosphere and subcultured every 3 d or upon reaching 80% confluency. For imaging, cells were seeded into LabTek chambered coverslips after cleaning as described above. Cells were labelled in growth medium for 120 min at 37° C. with benzylguanine-functionalized SiR (BG-SIR; Spirochrome) at 200 nM. After labelling, cells were washed repeatedly with growth medium and fixed for 20 min. with 3.7% (wt/vol) room temperature paraformaldehyde (PFA; EM grade; Electron Microscopy Sciences, USA) diluted in PBS. All samples were washed repeatedly with PBS after fixation and imaged directly after or kept in PBS at 4° C. until being imaged.

emCCD fluorescence microscopy data was acquired on a custom-built inverted microscope (Nikon Eclipse Ti; Nikon, Japan) with epifluorescence and total internal reflection fluorescence (TIRF) illumination modalities. The light source was a fiber-coupled multilaser engine (MLE-LFA; TOPTICA Photonics, Germany) equipped with 488, 561, and 640 nm continuous wave laser lines. A quadband dichroic mirror (AHF Analysetechnik, Germany) reflected the excitation light focused onto the backfocal plane of a 100×1.49 NA oil immersion objective (Apo TIRF; Nikon) while transmitting fluorescence light. Emitted signal was filtered with a quadband notch filter and a 690/70 nm bandpass filter (all AHF Analysetechnik, Germany) with the bandpass mounted in a motorized filter wheel (FW102C; Thorlabs, USA). After 1.3× magnification in an OptoSplit image splitter (CAIRN; UK) images were acquired with a back-illuminated emCCD camera (iXon Ultra 897; Andor, UK) at a pixel size of 96 nm in the sample plane. All microscope components were controlled using μManager (Edelstein et al., 2014).

### 4.2 Nuclear Pore Complex

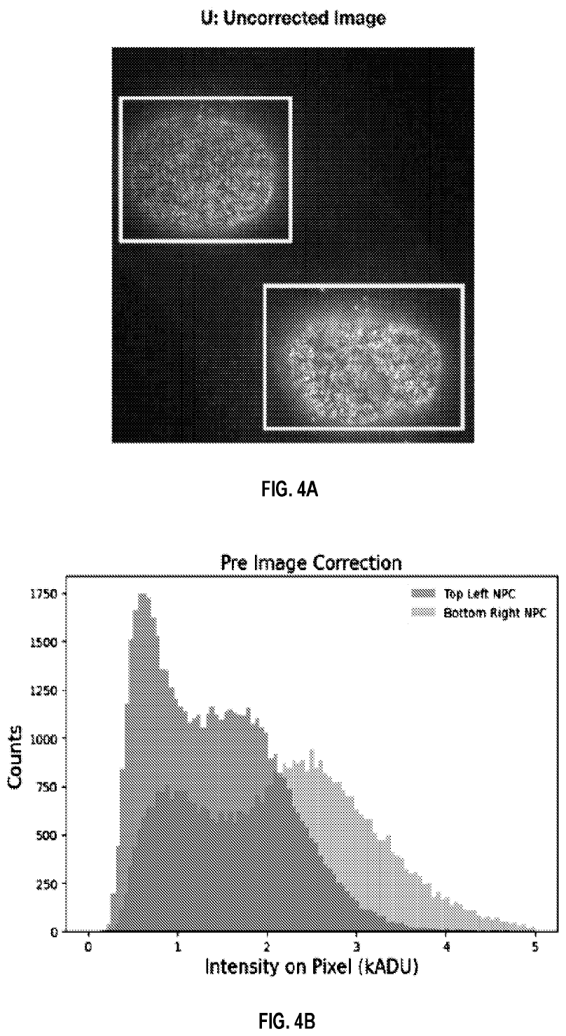

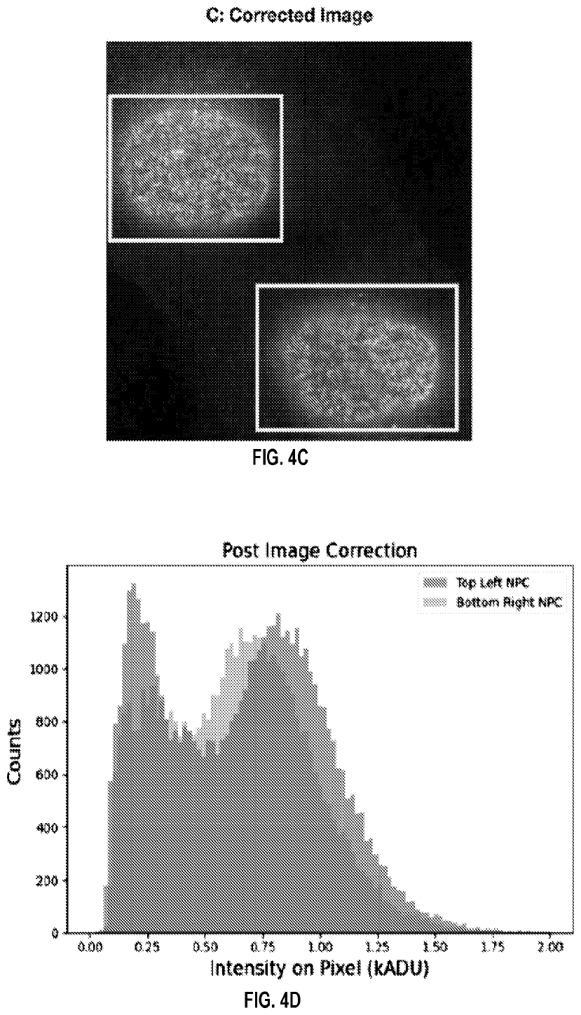

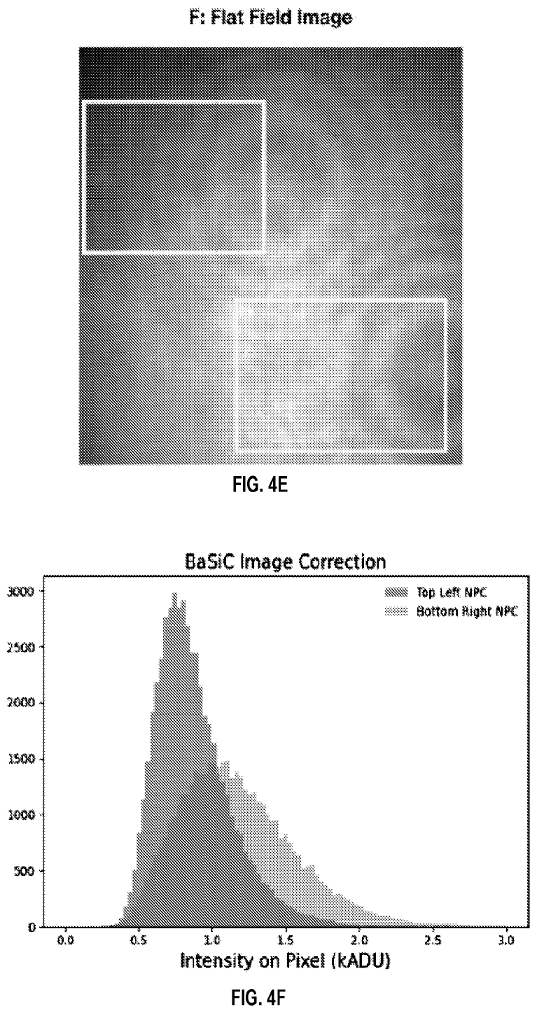

FIGS. 4A-4F show results for fluorescently-labeled nuclear core complex (NPCs) in U2OS cells under widefield illumination. Here, cells lie in an inhomogeneously-illuminated field (typical in microscopy) giving the appearance that the cell at the top right of the uncorrected image in FIG. 4A has fewer NPCs. Here, segment both cells and the intensity across pixels is expressed using histograms. As the illumination field is dimmer in the top field of the field of view, FIG. 4B shows poor overlap of the intensity histograms for both cells prior to correction. FIGS. 4C and 4D show correction using the methods outlined herein, and are compared to results obtained using a current state-of-the-art method called BaSiC (FIG. 4F) which primarily qualitatively smooths an image. By contrast, the correction results shown in FIGS. 4C and 4D quantitatively estimate the rescaled density of fluorophores. FIG. 4E shows inference using the methods outlined herein on a flat field which was estimated using flat-field images

For the experiment demonstrated in FIGS. 4A-4F, 100 frames of data were captured. There was no ROXS buffer but still very little bleaching at 5 percent laser power. Therefore, a small region of the data was taken where the illumination was approximately constant throughout the region. From dark images, the offset was estimated as σ=210 ADUs and the readout noise was estimated as σ=30 ADUs. The gain was estimated at about g=50 ADUs/Photo-electron. The flat field was measured by covering the surface with an 80 nM Atto647N solution multiple times and taking images of the surface after each coating. Averaging over all the different coatings and applying the averaged image as input to the systems outlined herein enabled inference of a smooth flat field. As can be seen in FIGS. 4A-4E, before correction, one nuclear pore was in the center of the flat field which made its intensity appear brighter in the sample image. Following inference of the illumination profile and subsequent correction of the image in view of the illumination profile, the nuclear pores were found to actually give off the same amount of data (e.g., the same amount of light, which means the same fluorophore density). This can be seen from the histograms of the intensities for both pores.

### 4.3 DNA Origami

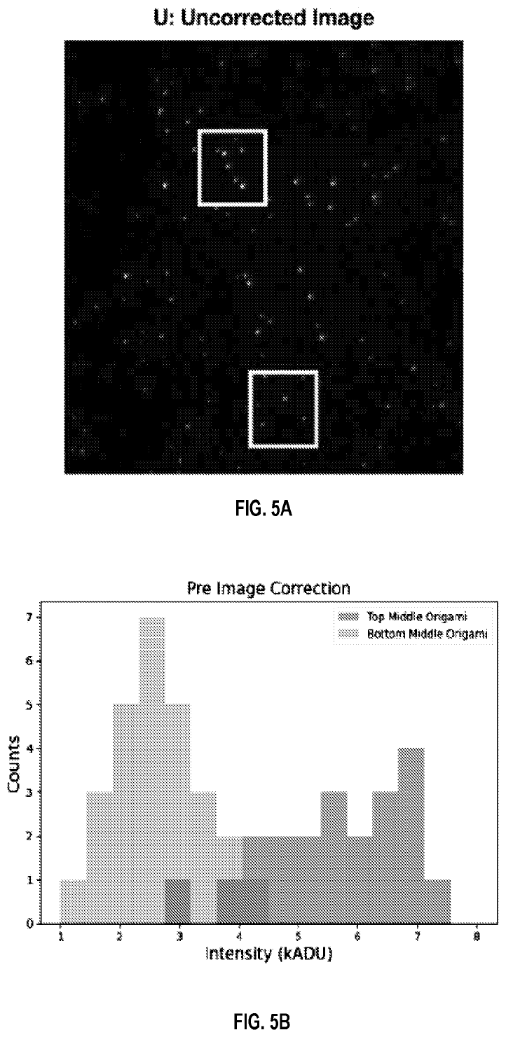

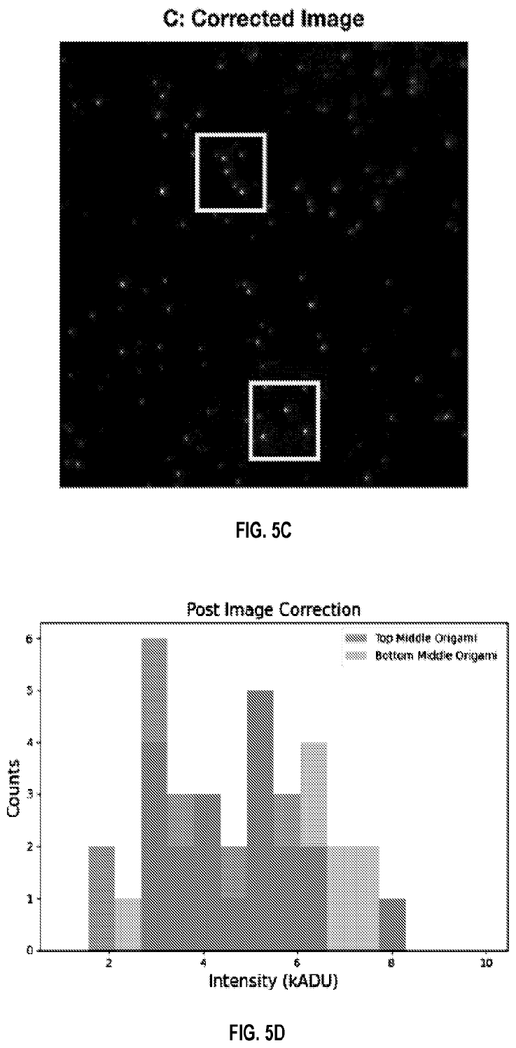

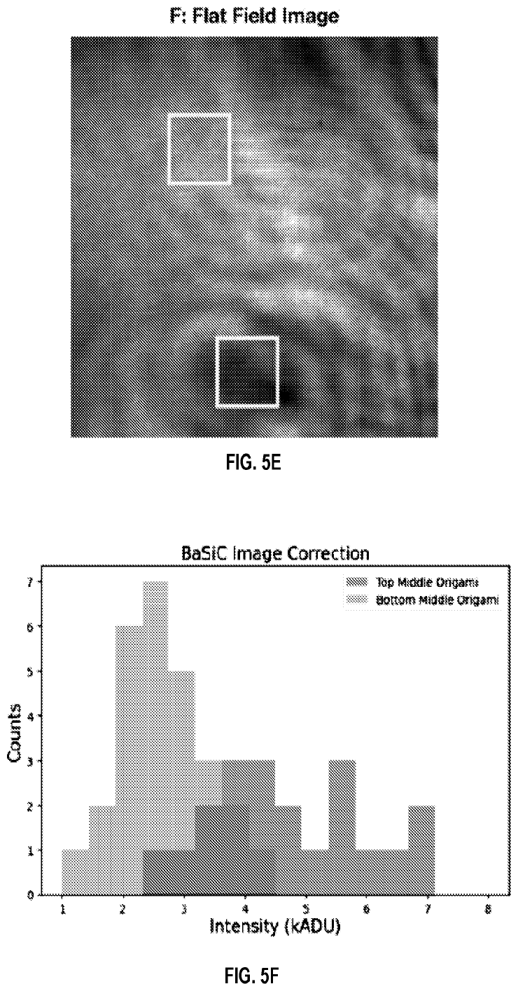

FIGS. 5A-4F show results for the methods outlined herein tested on images of DNA origami. Here, data was applied to an origami sample with 35 binding sites for ATTO647N. FIGS. 5A and 5B show the observation data before image correction. FIGS. 5C and 5D show the inference on the observation data image post image correction. FIG. 5E shows inference on the flat field estimated through flat field images using the methods outlined herein, and how the origami binding sites became similar intensity post image correction. There is a dark spot in the flat field at the bottom center of FIG. 5E. This made it so that the origami within the dark spot appeared dimmer than the origami in the higher illumination regions. The methods outlined herein accounted for the drop in illumination and corrected the brightness of these origami. FIGS. 5B and 5D respectively show pre-correction and post-correction histograms of the intensity of the origami located at the top middle portion of the screen where the illumination was bright and the intensity of the origami at the bottom middle portion of the screen where the illumination was dim. FIG. 5F shows a histogram based on BaSiC's image correction results for comparison.

For the experiment demonstrated in FIGS. 5A-5F, 200 frames were captured by the imaging device for DNA origami data. There was negligible bleaching at 5 percent laser power and some bleaching at 25 percent. The data with 5 percent laser power with ROXS buffer was the most stable measurement. A small region of the data was taken where the illumination was approximately constant throughout the region. From dark images, the offset was estimated as o=210 ADUs and the readout noise was estimated as o=30 ADUs. The gain was estimated at about g=50 ADUs/Photo-electron. The flat field was measured by covering the surface with a 80 nM Atto647N solution multiple times and taking images of the surface after each coating. Averaging over all the different coatings and applying the averaged image as input to the systems outlined herein enabled inference of a smooth flat field. The illumination for the TIRF measurements were measured at the same gain. As can be seen in FIGS. 5A and 5B, the uncorrected image suffers a decrease in brightness of the fluorophore clusters in the periphery region. The methods outlined herein, on the other hand, corrects this so that all clusters have the same average brightness as shown in FIGS. 5C and 5D.

### 4.4 Simulated Data

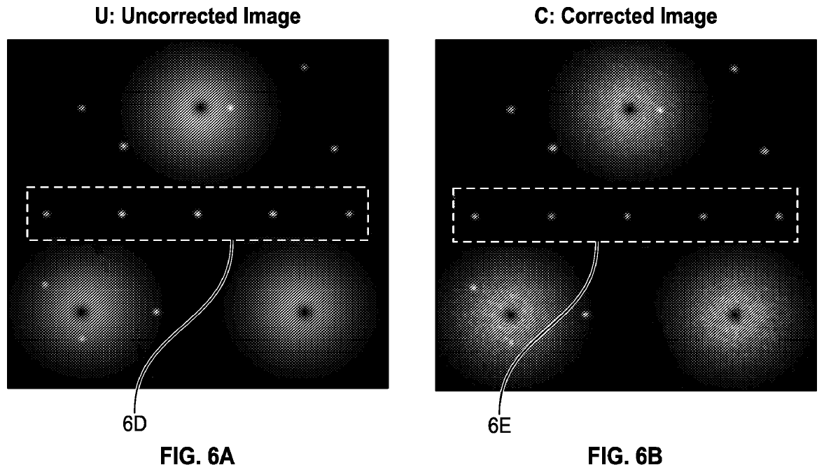

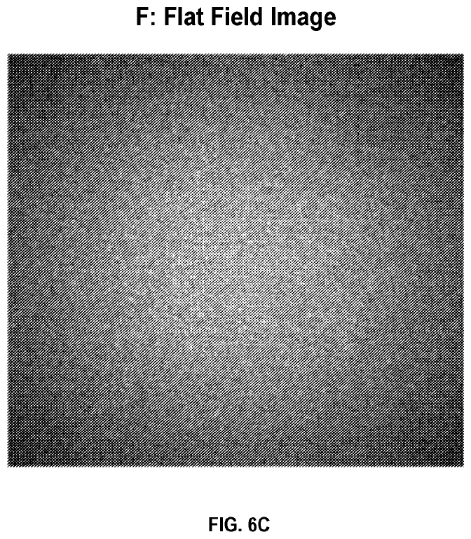

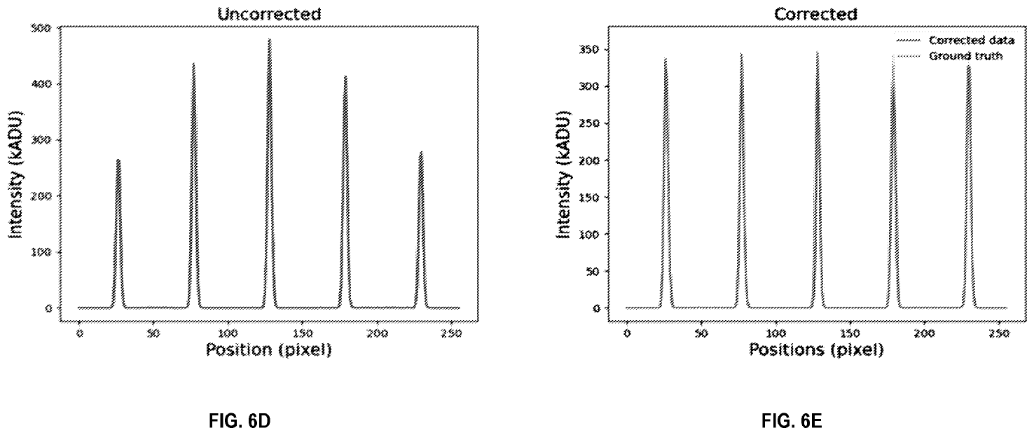

FIGS. 6A-6E show results for simulated data. Here, simulated data simulated had evenly spaced fluorescent clusters illuminated under inhomogeneous illumination. One-dimensional slices of the simulated data and inference images were created. The middle horizontal slice of each image was captured which simulated a row of discretely spaced fluorophores (see boxed areas of FIGS. 6A and 6B which respectively correspond with FIGS. 6D and 6E). FIG. 6D shows the one-dimensional slice of the data before correction and FIG. 6E shows the one-dimensional slice of the data after correction and compares it with the ground truth value.

For the experiment demonstrated in FIGS. 6A-6E, the simulated data had both sharp and smooth fluorophore density variation in order to show that the methods outlined herein work in both extremes and accurately estimate the ground truth. A 2-D Gaussian vignetting was applied to the image to simulate an aberrated illumination profile. The following parameters were used: g=50 ADUs/Photo-electron, c=0.002 Photo-electrons, and σ=30.00 ADUs. The vignetting was a 2-D Gaussian centered at our center pixel, (128,128), with an amplitude of 50 Photons/s and standard deviation of 100 pixels. For simplicity, it was assumed a priori that the offset has already been subtracted off. The methods outlined herein were applied using observation data including 10 bright field frames and 10 frames with the sample. As seen in FIGS. 6A-6E, the learned profile matches closely with the ground truth.

### 4.5 Discussion

The present disclosure presents a way to correct for inhomogeneous illumination and infer full distributions over camera parameters, achieved by utilizing the Bayesian paradigm to find the full likelihood of the camera model and sample the relevant parameters through a Gibbs sampling scheme. The methods outlined herein are benchmarked on simulated and experimental data, which showed that dim regions in uncorrected images can be recovered to their full brightness in a corrected image. The methods outlined herein go beyond existing methods, which are limited by the fact that they do not account for specific camera noise or internal parameters of the camera. It is for this reason that existing methods are used primarily for qualitative as opposed to quantitative image corrections.

The generality afforded by the methods outlined herein come at a computational cost. Some embodiments that were applied during benchmarking used Gaussian process regression, which has computational complexity that scales with the number of data cubed. As a naive implementation of the methods would not be tractable on an ordinary desktop, a simplification of the methods outlined herein may be employed to analyze segments of a trace individually and then correct each segment individually. As such, the methods outlined herein have a computational complexity that scales with the number of regions times the number of inducing points per region cubed, which could take days to run for large numbers of pixels (greater than 512×512 pixels).

Further improvements for implementation of the methods are contemplated. Firstly, in some implementations of the methods outlined herein, a precalibration step is performed in order to learn some camera parameters including the offset and gain. These parameters could alternatively be inferred simultaneously with the other parameters. Secondly, as described earlier, the methods outlined herein may be generally expensive because they involve sampling from a large posterior. Alternative implementations of the methods outlined herein may employ approximation schemes.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A system, comprising:
a processor in communication with a memory, the memory including instructions executable by the processor to:
access observation data including brightness data indicative of one or more light-emitting particles captured across a plurality of frames by an imaging device;
sample a set of probability values associated with observing the observation data for values of a plurality of parameters of a measurement model, the plurality of parameters including an illumination profile observable within the observation data; and
infer, based on the set of probability values and the observation data, a most probable illumination profile.

2. The system of claim 1, the measurement model including a posterior probability distribution expressive of a joint probability of observing a light-emitting particle of the one or more light-emitting particles at a particular location within a respective frame across the plurality of frames of the observation data for a fluorophore density and an external illumination profile.

3. The system of claim 1, the memory including instructions executable by the processor to:
apply a Gibbs sampling procedure to iteratively sample the set of probability values associated with the plurality of parameters from the measurement model.

4. The system of claim 1, the plurality of parameters further including a fluorophore density observable within the observation data.

5. The system of claim 1, the plurality of parameters further including one or more internal camera parameters that affect the observation data.

6. The system of claim 5, the one or more internal camera parameters including:
a gain of an electron multiplication register of the imaging device;
an offset of the imaging device; and
a standard deviation of readout noise associated with the imaging device.

7. The system of claim 1, the memory further including instructions executable by the processor to:
generate one or more images showing a corrected fluorophore density for a frame of the observation data based on the most probable illumination profile.

8. The system of claim 1, wherein the imaging device includes an Electron Multiplying Charge-Coupled Device camera that includes an electron multiplication register.

9. The system of claim 8, the measurement model incorporating a total probability of photon excitation, including:
a probability that a quantity of photons are incident on a pixel of the imaging device, conditioned on a mean number of incident photons absorbed at the pixel that corresponds with a brightness value of the observation data associated with the pixel; and
a probability that the electron multiplication register outputs a quantity of electrons, conditioned on a gain of the electron multiplication register and a quantity of input electrons incident at the electron multiplication register.

10. The system of claim 9, the measurement model incorporating a total probability of photon excitation, including:
a probability that an analog-digital unit signal associated with the pixel is equal to a particular value given a continuous illumination value of the illumination profile and normalized over the quantity of electrons outputted at the electron multiplication register, conditioned on the quantity of electrons outputted at the electron multiplication register, conditioned on an offset of the imaging device, and conditioned on a standard deviation of readout noise.

11. The system of claim 8, the measurement model incorporating a total probability of photon excitation, including:
a probability that a quantity of photons are absorbed as photoelectrons at a pixel of the imaging device, conditioned on a mean number of incident photons absorbed at the pixel and conditioned on a quantum efficiency associated with the imaging device.

12. The system of claim 11, the measurement model incorporating the total probability of photon excitation, including:
a probability that a quantity of spurious electrons associated with noise of the imaging device are emitted by the imaging device, conditioned on a mean number of spurious electrons; and
a probability that the electron multiplication register absorbs a quantity of input electrons given by convolution of the probability that the quantity of photons are absorbed as photoelectrons and the probability that the quantity of spurious electrons associated with clock induced charge noise of the imaging device are emitted by the imaging device, the quantity of input electrons including a subset of the spurious electrons and the photons absorbed at the pixel.

13. The system of claim 1, wherein the imaging device includes a scientific Complimentary Metal-Oxide Semiconductor (sCMOS) camera.

14. The system of claim 13, the measurement model incorporating a total probability of photon excitation, including:
a probability that a quantity of photons are absorbed by a pixel of the imaging device, conditioned on a mean number of incident photons absorbed at the pixel that corresponds with a brightness value associated with the pixel from the observation data; and
a probability that an analog-digital unit signal associated with the pixel is equal to a particular value, conditioned on a pixel gain of the pixel multiplied by the quantity of photons absorbed by the pixel, conditioned on an offset of the imaging device, and conditioned on a standard deviation of readout noise of the pixel.

15. A method, comprising:
accessing observation data including brightness data indicative of one or more light-emitting particles captured across a plurality of frames by an imaging device;
sampling a set of probability values associated with observing the observation data for values of a plurality of parameters of a measurement model, the plurality of parameters including an illumination profile observable within the observation data; and
inferring, based on the set of probability values and the observation data, a most probable illumination profile.

16. The method of claim 15, the measurement model including a posterior probability distribution expressive of a joint probability of observing a light-emitting particle of the one or more light-emitting particles at a particular location within a respective frame across the plurality of frames of the observation data for a fluorophore density and an external illumination profile.

17. The method of claim 15, further comprising:
applying a Gibbs sampling procedure to iteratively sample the set of probability values associated with the plurality of parameters from the measurement model.

18. The method of claim 15, the plurality of parameters further including a fluorophore density observable within the observation data.

19. The method of claim 15, the plurality of parameters further including one or more internal camera parameters that affect the observation data.

20. The method of claim 15, further comprising:
generating one or more images showing a corrected fluorophore density for a frame of the observation data based on the most probable illumination profile.
